(19) United States
(12) Patent Application Publication
(10) Pub. No.: US 2003/0023560 A1
(43) Pub. Date: Jan. 30, 2003

(54) Design asset information search system

(75) Inventor: Noriko Soma, Kasugai (JP)

Correspondence Address: STAAS & HALSEY LLP, 700 11TH STREET, NW, SUITE 500, WASHINGTON, DC, 20001, US

(73) Assignee: Fujitsu Limited, Kawasaki-shi (JP)

(21) Appl. No.: 10/092,463

(22) Filed: Mar. 8, 2002

(30) Foreign Application Priority Data
Jul. 27, 2001 (JP) 2001-227675

(51) Int. Cl. G06F 17/60

(52) U.S. Cl. 705/51; 707/3

(57) ABSTRACT

A search system for efficiently searching for IP information. When a user logs in to the search system, the search system retrieves information, which a group to which a user belongs has privilege to access, to generate a session information database. The search system searches the session information database for information that matches a search query input by the user.

### BACKGROUND OF THE INVENTION

The present invention relates to a design asset information search system, and more particularly, to a system for efficiently searching for design asset information, such as functional blocks or the like, that is used to design a semiconductor integrated circuit.

Nowadays, system large-scale integration circuits (system LSIs) are manufactured with functional blocks, such as a microprocessor unit (MPU) or a memory, formed on a single chip. The information of a functional block (IP macro) is referred to as a design asset (intellectual property). There is a demand for a system that facilitates the search for design asset information so that one can quickly and efficiently develop a system LSI provided with a new function.

A prior art IP information search system includes at least one server. Each server is installed in each company or office and connected to, for example, the Internet. The server stores IP information. An LSI designer uses the search system to conduct a global search for IP information in real time. When servers, each of which is installed in each department or each project team of a company, are connected to a local area network (LAN), a user in the company may conduct an efficient search for IP information.

In the prior art search system, the disk drive device of each server has an IP catalogue database (DB), which stores every IP catalogue. Each IP catalogue includes an index that indicates the function of an IP macro and substantial data of the IP macro. The disk drive device also has a category classification database (DB), which stores category names of the substantial data and IP catalogues classified in accordance with category.

The user operates a terminal computer, or a client computer, to search for the required IP information (IP macro) and retrieves IP catalogues found in the search. The user may also search for the required IP information (IP macro) using the category names of the category classification DB.

The IP information is an important intellectual property. Thus, access to the IP catalogues should be controlled. In other words, access privileges to the IP catalogues should be controlled. Access privileges are based on hierarchy, such as, company, department, or project team. The search system determines whether or not the substantial data of the IP catalogues may be disclosed whenever a search is conducted.

Therefore, in the prior art information search system, a disk drive device of a server has an access privilege database (DB) and a group definition database (DB). The access privilege DB defines the IP catalogues and substantial data that each hierarchy has privilege to access. The group definition DB stores information defining the hierarchy to which each user belongs. In other words, the access privilege definition DB defines the users having access to the IP catalogues and substantial data.

When a user searches for an IP catalogue, the prior art IP information search system provides the user with a search result of IP catalogues, which the user has privilege to access.

More specifically, the search system compares a search query, which is input by a user, with the IP catalogue DB. When an IP catalogue matching the search query is found, the search system refers to the access privilege DB and the group definition DB to determine whether the user has privilege to access the IP. If access to the IP catalogue is allowed, the search system displays the IP catalogue on the user's terminal computer. The search system also refers to the access privilege DB and the group definition DB to determine whether the user has privilege to access the substantial data of the IP catalogue.

When a user conducts a category search, the search system checks the access privilege of the user by referring to the category classification DB, the access privilege DB, and the group definition DB. The search system then displays the number of IP catalogues and their category names, which the user has privilege to access, on the user's computer terminal.

The number of users that use such search system has been increasing. The number of servers that undergo a search conducted by such search system has also been increasing. This has increased the amount of IP information, which a user may use. Thus, it has become easier for a user to find IP catalogues having the required functions. However, the increase in IP information has increased the amount of information collected in the access privilege DB and the group definition DB. Thus, the prior art search system requires much time to determine whether a user has the privilege to access an IP catalogue. This lowers efficiency when using the IP information.

### SUMMARY OF THE INVENTION

It is an object of the present invention to provide a search system that efficiently searches for design asset information.

To achieve the above object, the present invention provides a search system for searching design asset information to find information, which a user has privilege to access and which is requested by a user, and for providing the user with the privileged and requested information. The search system includes a first memory for storing the design asset information, a processor for retrieving information, which the user has privilege to access, from the design asset information, and a second memory for storing the retrieved privileged information.

The present invention further provides a system for searching design asset information. The system includes at least one server computer, and at least one client computer connected to the at least one server computer. The server computer includes a first memory for storing the design asset information, and a processor for retrieving information, which a user has privilege to access, from the design asset information and generating a retrieved information database of the retrieved privileged information when the user logs in to the server computer from the client computer. When the user inputs a search query in the client computer and sends the search query to the server computer, the server computer searches the retrieved information database for privileged information that matches the users query and provides the matched privileged information to the client computer.

The present invention further provides a method for searching design asset information stored in a memory. The method includes retrieving information, which a user has privilege to access, from the design asset information when the user logs in to a server computer from at least one client computer, generating a retrieved information database by collecting the retrieved privileged information, searching the retrieved information database, when the user inputs a search query through the client computer, for the privileged information that matches the search query, and providing the matched privileged information to the client computer.

The present invention further provides a program for searching design asset information stored in a memory to run a computer. The program includes retrieving information, which a user has privilege to access, from the design asset information when the user logs in to a server computer from at least one client computer, generating a retrieved information database by collecting the retrieved privileged information, searching the retrieved information database, when the user inputs a search query through the client computer, for the privileged information that matches the search query, and providing the matched privileged information to the client computer.

The present invention further provides a program storage device accessible by a computer, tangibly embodying a program of instructions executable by the computer to perform method steps for searching design asset information stored in a memory to run the computer. The program includes retrieving information, which a user has privilege to access, from the design asset information when the user logs in to a server computer from at least one client computer, generating a retrieved information database by collecting the retrieved privileged information; searching the retrieved information database, when the user inputs a search query through the client computer, for the privileged information that matches the search query; and providing the matched privileged information to the client computer.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram of an IP search system according to an exemplary embodiment of the present invention;

FIG. 2 is a partial block diagram of the search system of FIG. 1;

FIG. 3 is a schematic diagram of a database according to the present invention;

FIG. 4 is an explanatory diagram illustrating fields of the database of FIG. 3;

FIG. 5 is a flowchart illustrating a procedure for generating session information according to the present invention;

FIG. 6 is a block diagram illustrating a search process performed by the search system of FIG. 1.

### DETAILED DESCRIPTION OF THE PREFERRED EMBODIMENT

An apparatus for searching for design asset information (IP information), or a search system 11, according to a preferred embodiment of the present invention will now be discussed.

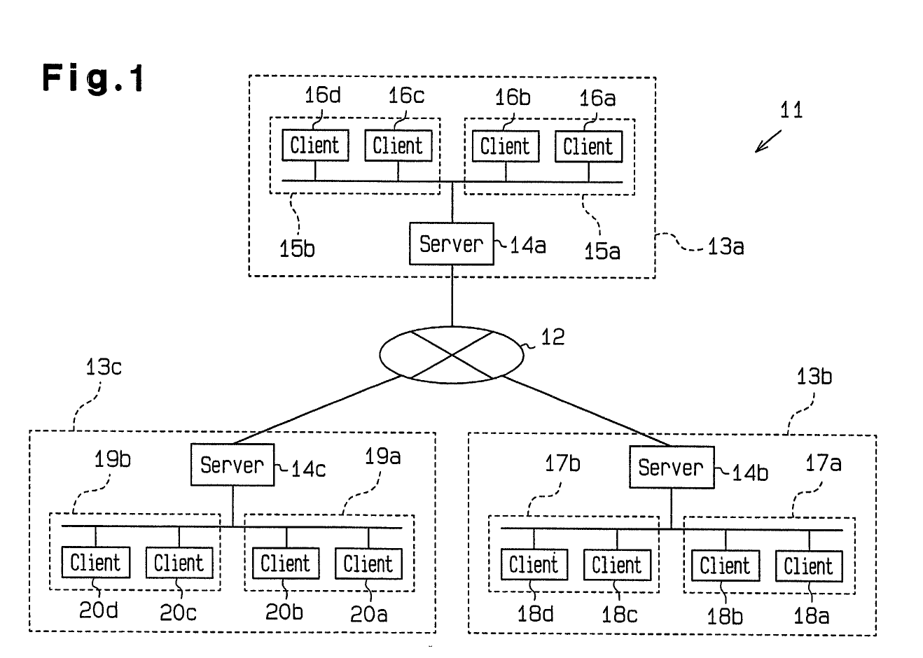

Referring to FIG. 1, the search system 11 includes first to third server computers 14a-14c, which are connected to a network 12 such as the Internet. The first to third server computers 14a-14c are respectively installed in first to third companies (or offices) 13a-13c.

The first server 14a is connected to client computers 16a, 16b, 16c, 16d through, for example, a local area network (LAN). The client computers 16a, 16b are installed in a department 15a of the first company 13a. The client computers 16c, 16d are installed in a department 15b of the first company 13a.

In the second company 13b, the second server 14b is connected to client computers 18a, 18b, which are installed in department 17a, and to client computers 18c, 18d, which are installed in department 17b. In the third company 13c, the third server 14c is connected to the client computers 20a, 20b, which are installed in department 19a, and to client computers 20c, 20d, which are installed in department 19b.

Two or more of the servers 14a-14c may be installed in each of the first to third companies 13a-13c. Further, one or more server may be installed in each of the departments 15a, 15b, 17a, 17b, 19a, and 19b. If each of the departments 15a, 15b, 17a, 17b, 19a, 19b have multiple project teams, one or more servers may be provided for each project team.

A user operates one of the client computers 16a-16d, 18a-18d, 20a-20d to search for and retrieve required IP information from the IP information collected in the search system 11.

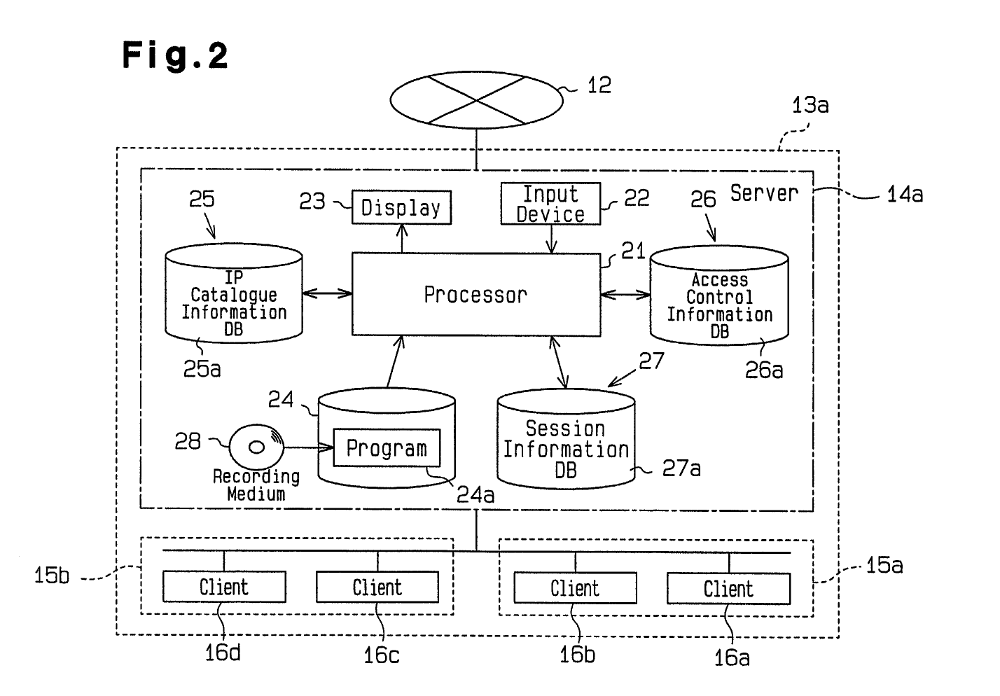

The search system 11 of the first company 13a will now be discussed with reference to FIG. 2. The search system 11 used in the second and third companies 13b, 13c is similar to that of the search system 11 used in the first company 13a and will thus not be discussed.

The first server 14a includes a processor 21, an input device 22, a display 23, a first disk drive device 24, a second disk drive device 25, a third disk drive device 26, and a fourth disk drive device 27. The input device 22, the display 23, the first disk drive device 24, the second disk drive device 25, the third disk drive device 26, and the fourth disk drive device 27 are connected to the processor 21. The second and third disk drive devices 25, 26 function as a first memory, and the fourth disk drive device 27 functions as a second memory.

The input device 22 includes a keyboard and a mouse (not shown) and is used by a user to provide instructions and parameters to the processor 21. The display 23, which includes a VDT, a monitor, and a printer, displays various information related to processes performed by the search system 11.

The first to fourth disk drive devices 24-27 include a magnetic disk device, and optical disc device, and a magneto-optic disc device. In FIG. 2, the disk drive devices 24-27 are divided in accordance with the type of stored data. However, the disk drive devices 24-27 may be integrated into a single disk drive device. Further, each of the disk drive devices 24-27 may be configured by combining a plurality of separate disk drive devices.

The first disk drive device 24 stores program data 24a, which is executed by the processor 21. The program data 24a includes a control program, which controls the second to fourth disk drive devices 25-27. The program data 24a may include a plurality of programs, each serving to perform at least one function.

The program data 24a is provided to a recording medium 28. The recording medium 28 is a computer-readable portable medium, such as a memory card, a floppy disk, an optical disc (e.g., CD-ROM, DVD-ROM), or a magneto-optic disc (e.g., MO, MD). In addition to a recording medium that records a program directly executed by a computer, the recording medium 28 may be a recording medium that records a program executed when installed in other recording media (e.g., hard disk) or a recording medium that records a coded or compressed program.

The recording medium 28 may be a main memory or an auxiliary memory of another network-connected computer. The program data 24a is temporarily copied to or installed in the first disk drive device 24 from the recording medium 28. The program data 24a is then loaded to a main memory (not shown) and executed by the processor 21. Alternatively, the program data 24a may be directly loaded to the main memory from the recording medium 28 and be executed by the processor 21.

The data processed by the processor 21 is divided and stored in the second to fourth disk drive devices 25-27. In response to an instruction received from the input device 22, the processor 21 uses the data of the second to fourth disk drive devices 25-27 to perform a process in accordance with the program data 24a.

The second disk drive device 25 stores a first database, or an IP catalogue information DB 25a, in which IP catalogues are collected. An IP catalogue refers to information (IP macro) of devices such as a microprocessor unit (MPU) or a memory (i.e., functional blocks), which are configured on a system large-scale integration circuit chip (system LSI). The IP catalogues include standardized indexes indicating the function of each IP macro.

The IP catalogue information DB 25a collects management information and substantial data for each IP catalogue. Further, the IP catalogue information DB 25a collects category classification information that classifies IP catalogues in accordance with the category of their substantial data. In the preferred embodiment, the IP catalogue information includes the management information, substantial data, and category classification information of the IP catalogues.

The third disk drive device 26 stores a second database, or an access control information DB 26a, which collects access control (access privilege) information of the IP catalogue information in correspondence with each group. In the search system 11, hierarchical groups (access privilege groups), such as the first to third companies 13a-13c or each of the departments 15a, 15b, 17a, 17b, 19a, 19b, are defined. Access to of IP information is controlled based on the groups.

The first to third companies 13a-13c are each defined as an upper rank group. The departments 15a, 15b, 17a, 17b, 19a, 19b are each defined as a lower rank group. A user (IP information user) belongs to at least one of the lower rank and upper rank groups. The access control information of the access control information DB 26a includes information for determining whether the group, to which the user belongs, has privilege to access the IP catalogue information. The search system 11 determines whether or not a user has the privilege to access IP catalogues based on the access control information and provides a user with the privileged IP catalogues.

The fourth disk drive device 27 stores a third database, or a session IP catalogue information DB (hereafter referred to as session information DB) 27a. When the user holds a session to search for data, the session information DB 27a collects information, which the user's group has privilege to access, from the IP catalogue information DB 25a, in which IP catalogue information (management information, substantial data, category classification information) is collected, during the session.

More specifically, each user establishes a single session. The session information DB 27a stores the IP catalogue information, which the user's group has privilege to access and which is retrieved from the IP catalogue information DB 25a. Further, the session information DB 27a is generated when the user logs in to the search system 11 and is held until the user logs out from the search system 11. In other words, the session information DB 27a is held throughout the user's session.

When the user logs in to the search system 11 from the client computers 16a-16d, the first server 14a refers to the IP catalogue information DB 25a and the access control information DB 26a to generate the session information DB 27a, which only includes information privileged to the user. The first server 14a provides the IP catalogue information of the session information DB 27a to the client computers 16a-16d during the session.

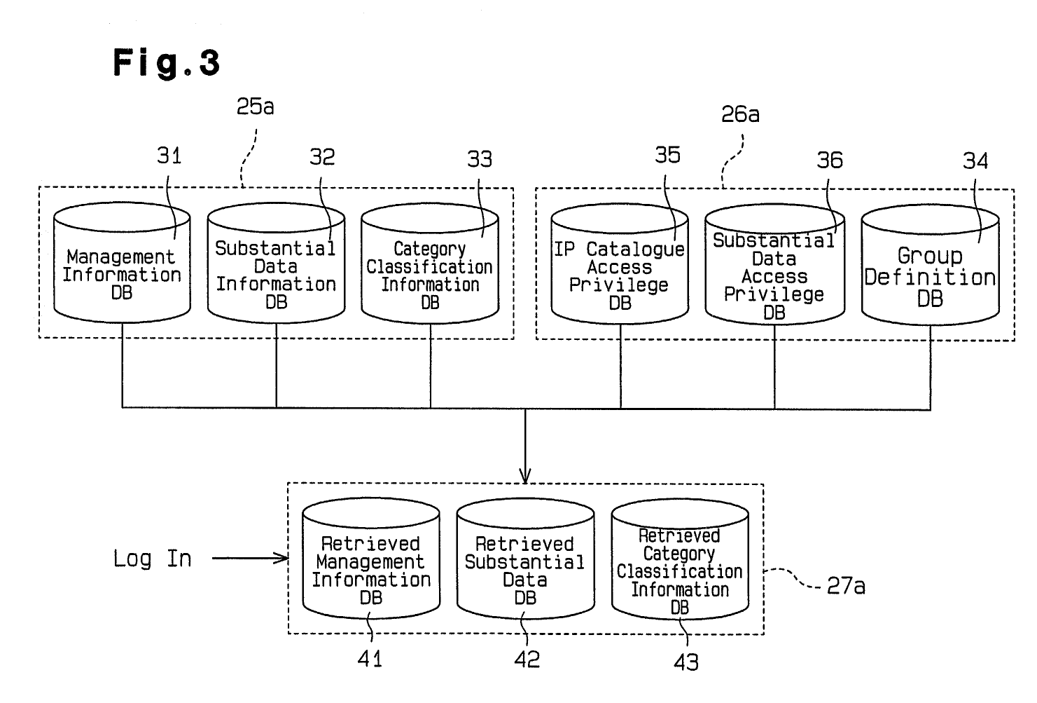

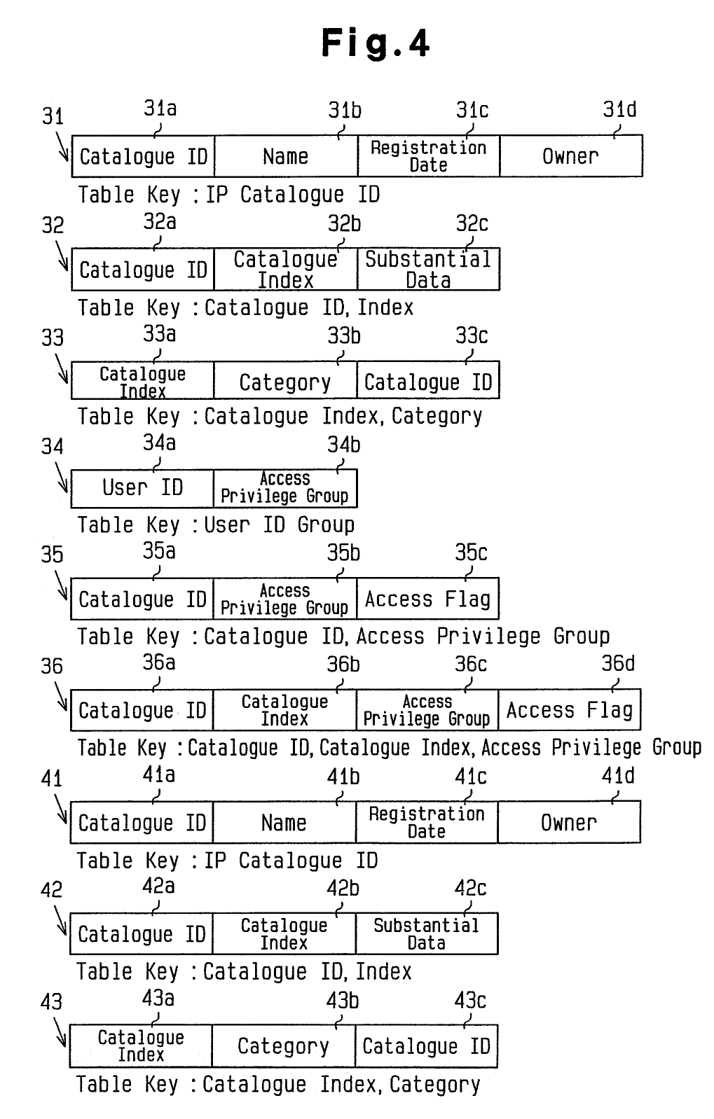

FIG. 3 is a schematic diagram of the IP catalogue information DB 25a, the access control information DB 26a, and the session information DB 27a. FIG. 4 illustrates the fields of a record in databases 31-36 and 41-43. The term “table key” in FIG. 4 refers to items subject to the search.

The IP catalogue information DB 25a includes an IP catalogue management information DB (hereafter referred to as management information DB) 31, an IP catalogue substantial data information DB (hereafter referred to as substantial data information DB) 32, and a category classification information DB 33.

For each IP catalogue, the management information DB 31 stores a management ID (hereafter referred to as catalogue ID) and IP catalogue management information (name, registration date, and owner) respectively in fields 31a-31d.

For each IP catalogue, the substantial data information DB 32 stores a catalogue ID, an IP catalogue index, and substantial data (e.g., power supply voltage, operation frequency, power consumption) respectively in fields 32a-32c.

For each IP catalogue, the category classification information DB 33 stores an IP catalogue index, a substantial data category, and a catalogue ID respectively in fields 33a-33c. In the category classification information DB 33, the classification categories are identified by category names, and IP catalogues are identified by catalogue IDs.

The access control information DB 26a includes a group definition DB 34, an IP catalogue access privilege DB (hereafter referred to as catalogue access privilege DB) 35, and an IP catalogue substantial data access privilege DB (hereafter referred to as substantial data access privilege DB) 36.

The group definition DB 34 stores a user ID and the name of the group to which the user belongs (access privilege group) respectively in fields 34a and 34b. The group definition DB 34 defines the group to which each user belongs. The group definition DB 34 is used to determine the access privilege of each IP catalogue in units of groups.

The user belongs to at least one access privilege group. The access privilege group name identifies the group to which a user belongs. If the user belongs to a plurality of groups, a plurality of group names are recorded in the field 34b. That is, in the preferred embodiment, each of the companies 13a-13c and each of the departments 15a, 15b, 17a, 17b, 19a, 19b is an access privilege group. In the preferred embodiment, a user belonging to department 15a also belongs to the first company 13a.

For each IP catalogue, the catalogue access privilege DB 35 stores a catalogue ID, access privilege groups, and an access flag respectively in fields 35a-35c. The catalogue access privilege DB 35 collects information indicating which IP catalogue management information may or may not be accessed by which access privilege group. For example, if the access flag is 1, the groups recorded in field 35b have privileges to access the catalogue ID recorded in field 35a. If the access flag is 0, the groups recorded in the field 35b do not have privilege to access the catalogue ID recorded in field 35a.

For each IP catalogue, the substantial data access privilege DB 36 stores a catalogue ID, a catalogue index, access privilege groups, and an access flag respectively in fields 36a-36d. The substantial data access privilege DB 36 collects information indicating which access privilege group may or may not access which IP catalogue substantial data. For example, if the access flag is 1, the groups recorded in field 36c have privilege to access the substantial data corresponding to the catalogue ID recorded in field 36a and the catalogue indexes recorded in field 36b. If the access flag is 0, the groups recorded in field 36c do not have privilege to access the substantial data corresponding to the catalogue ID recorded in field 36a and the catalogue indexes recorded in field 36b.

The session information DB 27a is generated whenever a user accesses the search system 11. The session information DB 27a includes a retrieved management information DB 41, a retrieved substantial data information DB 42, and a retrieved category classification information DB 43. The retrieved management information DB 41 includes session identification information, or session management IDs.

The processor 21 retrieves the management information of IP catalogues, which the user has privilege to access, from the management information DB 31 by referring to the group definition DB 34 and the catalogue access privilege DB 35 to generate the retrieved management information DB 41. Accordingly, the field of the retrieved management information DB 41 is the same as the field of the management information DB 31. More specifically, the retrieved management information DB 41 stores a catalogue ID and retrieved management information respectively in fields 41a to 41d for each IP catalogue. In other words, the management information of an IP catalogue and its catalogue ID, which are retrieved when the user logs in, are recorded in fields 41a-41d of the retrieved management information DB 41. A session management ID is added for each session in the retrieved management information DB 41. The retrieved management information DB 41 is held during each session. The retrieved management information DB 41 is generated for each group to which the user belongs.

The processor 21 retrieves the substantial data, which the user has privilege to access, from the substantial data information DB 32 by referring to the group definition DB 34 and the substantial data access privilege DB 36 to generate the retrieved substantial data information DB 42. Accordingly, the field of the retrieved substantial data information DB 42 is the same as the field of the substantial data information DB 32. More specifically, the retrieved substantial data information DB 42 stores a catalogue ID, a catalogue indexes, and the retrieved substantial data respectively in fields 42a-42c for each IP catalogue. A session management ID is added for each session in the retrieved substantial data information DB 42. The retrieved substantial data information DB 42 is held during each session. The retrieved substantial data information DB 42 is generated for each group to which the user belongs.

The processor 21 retrieves the category classification, which the user has privilege to access, from the category classification information DB 33 by referring to the group definition DB 34 and the catalogue access privilege DB 35 to generate the retrieved category classification information DB 43. Accordingly, the field of the retrieved category classification information DB 43 is the same as the field of the category classification information DB 33. More specifically, the retrieved category classification information DB 43 stores a catalogue index, a classification category, and a catalogue ID respectively in fields 43a-43c for each IP catalogue. A session management ID is added for each session to the retrieved category classification information DB 43. The retrieved category classification information DB 43 is held during each session. The retrieved category classification information DB 43 is generated for each group to which the user belongs.

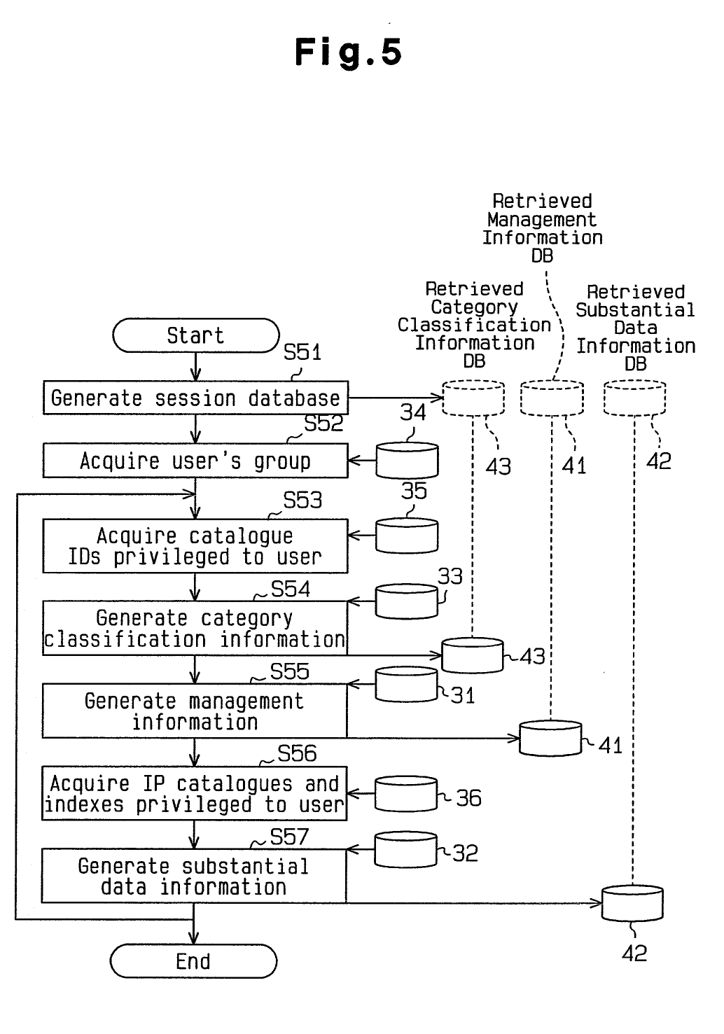

The generation of the session information 27a will now be described with reference to the flowchart of FIG. 5. The following description is based on a state in which the user logs in to the first server 14a from the client computer 16a to use the search system 11.

When a user logs in to the search system 11 to start a session, in step S51, the first server 14a generates the retrieved management information DB 41, the retrieved substantial data information DB 42, and the retrieved category classification information DB 43. Further, the first server 14a adds the same session management ID to the DBs 41, 42 and 43. Preferably, the session management ID appears in the filenames of the DBs 41, 42 and 43.

In step S52, the first server 14a acquires the name of the access privilege group, to which the user belongs, from the group definition DB 34. When the user belongs to multiple access privilege groups, the first server 14a acquires the name of every access privilege group.

In step S53, the first server 14a acquires the catalogue IDs of the records that the groups acquired in step S52 have privilege to access. More specifically, the first server 14a acquires the catalogue IDs of the records, which includes the names of the groups acquired from step S52 in field 35b and which access flag is set to 1 in field 35c, from the records of the catalogue access privilege DB 35.

In step S54, the first server 14a retrieves the catalogue indexes and classification categories (category names) of only the records having the catalogue IDs acquired in step S53 from the category classification information DB 33. The first server 14a then copies the retrieved catalogue indexes, classification categories, and the catalogue IDs of the records to the retrieved category classification information DB 43.

In step S55, the first server 14a retrieves the management information (catalogue name, registration date, and owner) of only the records having the catalogue IDs acquired in step S53 from the management information DB 31 and copies the retrieved management information and the catalogue IDs of the records to the retrieved management information DB 41.

In step S56, the first server 14a acquires the catalogue indexes of the records that the groups acquired in step S52 have privilege to access and that have the catalogue IDs acquired in step S53 from the substantial data access privilege DB 36. In step S57, the first server 14a retrieves the substantial data of the records having the catalogue indexes acquired in step S56 from the substantial data information DB 32 and copies the retrieved substantial data and the catalogue IDs of the records to the retrieved substantial data information DB 42.

In this manner, the information to which the user has the privilege to access is stored in the session information DB 27a, that is, the retrieved management information DB 41, the retrieved substantial data information DB 42, and the retrieved category classification information DB 43.

If the names of a plurality of access privilege groups are acquired in step S52, the first server 14a repeats steps S53 to S57 to generate a session information DB 27a for each access privilege group. If two access privilege groups have privilege to access a certain IP catalogue, the catalogue ID is copied to the session information DB 27a of only one of the access privilege groups in steps S54, S55, and S57.

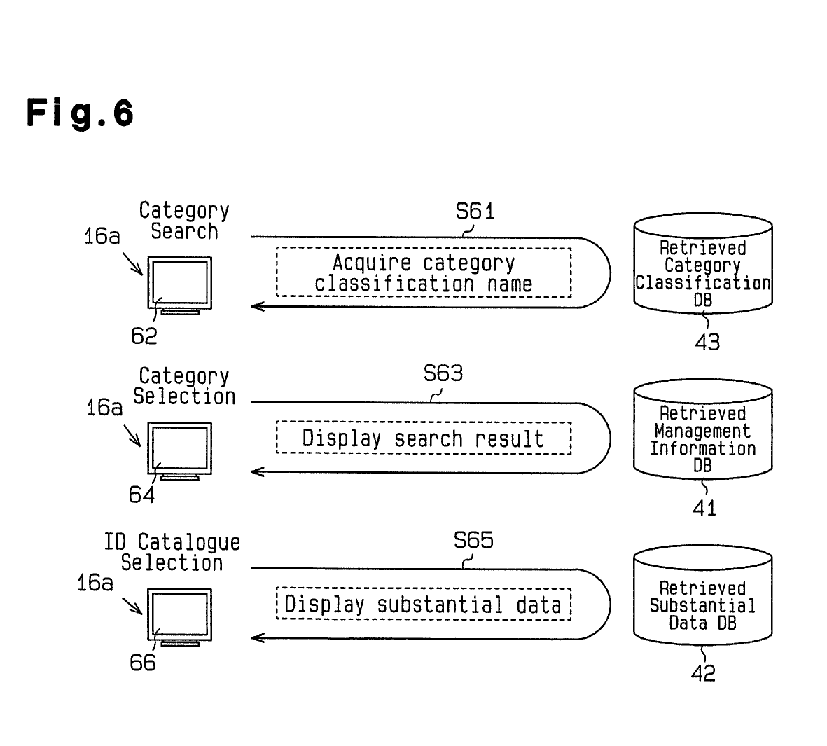

The procedure for conducting a search with the search system 11 will now be discussed with reference to FIG. 6.

When a user logs in to the first server 14a from the client computer 16a, the first server 14a performs steps S51-S57 to generate the session information DB 27a (i.e., retrieved management information DB 41, retrieved substantial data information DB 42, and retrieved category classification information DB 43).

When the user performs a category search, the client computer 16a sends the search query input by the user to the first server 14a. The first server 14a counts the number of the IP catalogues that belong to the category matching the user's query from the retrieved category classification information DB 43 and sends a search result 62, which includes the counted number and category classification names, to the client computer 16a. The client computer 16a displays the search result 62, which includes the counted number and category classification names, received from the first server 14a (step S61).

From the category classification names of the search result 62, the user selects the category classification name, to which he or she wants to refer. The client computer 16a notifies the first server 14a of the selected category classification. The first server 14a then sends the management information (catalogue name, registration date, owner) of every IP catalogue belonging to the category classification selected by the user in the retrieved management information DB 41 to the client computer 16a. The client computer 16a displays the search result 64, which includes the received management information (step S63).

The user then selects the IP catalogues, to which he or she wants to refer. The client computer 16a notifies the first server 14a of the selected IP catalogue. The first server 14a sends the substantial data of the IP catalogue selected by the user in the retrieved substantial data information DB 42 to the client computer 16a. The client computer 16a then displays a search result 66, which includes the received substantial data (step S65).

The preferred embodiment has the advantages described below.

(1) The search system 11 generates a session information DB 27a corresponding to the access privilege group, to which the user belongs. Information, which the user has the privilege to access, is collected in the session information DB 27a. The search system 11 searches for and acquires the IP catalogue information, which matches the functions required by the user, from the session information DB 27a and provides the user with the acquired information. Accordingly, the search system 11 does not have to determine whether the user has privilege to access the search result each time the user conducts a search. Further, the session information DB 27a stores only some of the information in the search system 11. This shortens the search time of the search system 11 and improves the search efficiency.

(2) The session information DB 27a is generated when the user logs in to the search system 11 and is held during that session. Accordingly, information, which the user has the privilege to access, is collected in the session information DB 27a when the user is logged in. Thus, the search system has an optimal field of search. This improves the search efficiency and efficiently provides the user with information.

(3) The session information DB 27a includes the retrieved management information DB 41, the retrieved substantial data information DB 42, and the retrieved category classification information DB 43. The search system 11 acquires the information required by the user from the DBs 41-43 in accordance with the user's search query (e.g., free word query or category query). This improves the search efficiency.

It should be apparent to those skilled in the art that the present invention may be embodied in many other specific forms without departing from the spirit or scope of the invention. Particularly, it should be understood that the present invention may be embodied in the following forms.

The group to which the user belongs is not limited to the companies 13a-13c and the departments 15a, 15b, 17a, 17b, 19a, 19b and may be further fractionated.

A plurality of servers may be installed in each of the companies 13a-13c. Further, one or more servers may be provided for each project team or each of the departments 15a, 15b, 17a, 17b, 19a, 19b. By installing a plurality of servers, a user of a company may efficiently use the IP information.

Instead of the IP catalogue information, the search system 11 may be used to search for other kinds of collected information.

In addition to the catalogue name, the registration date, and owner of the IP catalogue, the retrieved management information DB 41 may store other types of information.

All such variations are considered to be within the scope and spirit of the present invention as defined by the following claims and their legal equivalents.

What is claimed is:

1. A search system for searching design asset information to find information, which a user has privilege to access and which is requested by the user, and for providing the user with the privileged and requested information, the search system comprising:
a first memory for storing the design asset information;
a processor for retrieving information, which the user has privilege to access, from the design asset information; and
a second memory for storing the retrieved privileged information.

2. The search system according to claim 1, wherein the first memory includes a first database for collecting the design asset information and a second database for collecting access control information used to set access privileges to the design asset information, the processor refers to the access control information to retrieve the privileged information from the first database, and the second memory includes a third database for collecting the privileged information.

3. The search system according to claim 2, wherein the access control information includes information of access privilege groups for setting the access privileges to the design asset information and information for defining at least one of the access privilege groups to which the user belongs, and wherein the third database is generated for each of the access privilege groups.

4. The search system according to claim 2, wherein the third database is generated when the user starts a session and is held until the session is terminated.

5. The search system according to claim 2, further comprising:
at least one server including the first database, the second database, and the third database; and
at least one client computer connected to the server through a network;
wherein the user inputs a search query in the client computer, the client computer sends the search query to the server, the server acquires design asset information that matches the search query from the third database, and the server provides the acquired design asset information to the client computer.

6. The search system according to claim 5, wherein the design asset information is IP catalogue information that includes management information, substantial data, and category classification information of IP catalogues, wherein the processor refers to the access control information to retrieve the management information, the substantial data, and the category classification information of IP catalogues, which the user has privilege to access, and wherein the third database includes a first retrieved information database for collecting the retrieved management information, a second retrieved information database for collecting the retrieved substantial data, and a third retrieved information database for collecting the retrieved category classification information.

7. The search system according to claim 6, wherein the server searches the first retrieved information database for the management information of IP catalogues that match the search query of the user and provides the management information of the matched IP catalogues to the client computer.

8. The search system according to claim 6, wherein the server searches the second retrieved information database for the substantial data of IP catalogues that match the search query of the user and provides the substantial data of the matched IP catalogues to the client computer.

9. The search system according to claim 6, wherein the server searches the third retrieved information database for the category classification information of IP catalogues that match the search query of the user and provides the category classification information of the matched IP catalogues to the client computer.

10. A system for searching design asset information comprising:
at least one server computer; and
at least one client computer connected to the at least one server computer, wherein the server computer includes:
a first memory for storing the design asset information; and
a processor for retrieving information, which a user has privilege to access, from the design asset information and generating a retrieved information database of the retrieved privileged information when the user logs in to the server computer from the client computer, wherein, when the user inputs a search query in the client computer and sends the search query to the server computer, the server computer searches the retrieved information database for privileged information that matches the users query and provides the matched privileged information to the client computer.

11. The search system according to claim 10, wherein the retrieved information database is held from when the user logs in to the server computer to when the user logs out from the server computer.

12. The search system according to claim 10, wherein the user belongs to at least one group, wherein the privileged information is information, which the group the user belongs to has privilege to access.

13. The search system according to claim 10, wherein the first memory includes an original database for collecting the design asset information and a control database for collecting access control information of the design asset information, wherein the processor refers to the access control information to retrieve the privileged information from the original database.

14. The search system according to claim 13, wherein each piece of the design asset information includes an index and substantial data, and wherein the control database includes a definition database defining a group to which the user belongs, a catalogue access privilege database defining groups having privilege to access the index, and a substantial data access privilege database defining groups having privilege to access the substantial data.

15. A method for searching design asset information stored in a memory, the method comprising the steps of:
retrieving information, which a user has privilege to access, from the design asset information when the user logs in to a server computer from at least one client computer;
generating a retrieved information database by collecting the retrieved privileged information;
searching the retrieved information database, when the user inputs a search query through the client computer, for the privileged information that matches the search query; and
providing the matched privileged information to the client computer.

16. A program for searching design asset information stored in a memory to run a computer, the program comprising the steps of:
retrieving information, which a user has privilege to access, from the design asset information when the user logs in to a server computer from at least one client computer;
generating a retrieved information database by collecting the retrieved privileged information;
searching the retrieved information database, when the user inputs a search query through the client computer, for the privileged information that matches the search query; and
providing the matched privileged information to the client computer.

17. A program storage device accessible by a computer, tangibly embodying a program of instructions executable by the computer to perform method steps for searching design asset information stored in a memory to run the computer, the program comprising the steps of:
retrieving information, which a user has privilege to access, from the design asset information when the user logs in to a server computer from at least one client computer;
generating a retrieved information database by collecting the retrieved privileged information;
searching the retrieved information database, when the user inputs a search query through the client computer, for the privileged information that matches the search query; and
providing the matched privileged information to the client computer.
